(19) United States
(12) Patent Application Publication
(10) Pub. No.: US 2015/0276128 A1
(43) Pub. Date: Oct. 1, 2015

(54) PUMP ASSEMBLY FOR CRYOGENIC LIQUID STORAGE TANK

(71) Applicant: Transfuels Retail Operations LLC, Salt Lake City, UT (US)

(72) Inventors: James Hulse, Layton, UT (US); Ivan K. Hall, Beach City, TX (US); Luis E. Hernandez, Pasadena, TX (US); Anthony B. Morreale, San Leon, TX (US); Mark J. Ollweiller, Lakewood, CO (US)

(21) Appl. No.: 14/676,803

(22) Filed: Apr. 1, 2015

Related U.S. Application Data
(60) Provisional application No. 61/973,749, filed on Apr. 1, 2014.
(60) Provisional application No. 62/025,300, filed on Jul. 16, 2014.

(51) Int. Cl. F17C 1/12

(52) U.S. Cl. CPC F17C 1/12

(57) ABSTRACT

A liquid storage tank system that includes a liquid storage tank, a receiver, and a pump housing. The liquid storage tank includes an inner surface that defines an interior of the liquid storage tank, the receiver is secured to the inner surface and the receiver defines a receptacle, and the pump housing defines a chamber within which a liquid pump is retained, the receptacle being sized to removably receive and orientate the pump housing in a vertical orientation.

### CROSS-REFERENCE TO RELATED APPLICATIONS

This application claims the benefit of U.S. Provisional Patent Application No. 61/973,749, filed Apr. 1, 2014, and U.S. Provisional Patent Application No. 62/025,300, filed Jul. 16, 2014, which are incorporated herein by reference.

### FIELD

The present disclosure relates generally to cryogenic liquid storage tanks, and more specifically, to apparatuses, systems, and methods for pumping cryogenic liquid from cryogenic liquid storage tanks.

### BACKGROUND

Tanks for storing cryogenic liquid are well known in the art. Cryogenic liquids are liquefied gases. Some cryogenic liquids include liquid natural gas (LNG), nitrogen, liquid nitrogen, liquid oxygen, liquid carbon dioxide, liquid methane, and liquid hydrogen. In order to maintain the gases in a liquefied state, the temperature of the liquefied gases must remain below a boiling point of the gases. Accordingly, typical cryogenic liquid storage tanks are configured to store and thermally insulate a cryogenic liquid. Cryogenic liquid storage tanks can be positioned above or below ground.

Cryogenic liquid storage tanks include liquid pumps positioned within the tanks. The pumps are operable to pump cryogenic liquid stored in the tanks out of the tanks and into supply lines. From the supply lines, the cryogenic liquid can be received in other cryogenic liquid storage devices, such as mobile storage tanks, vehicle fuel storage tanks, machine fuel storage tanks, and the like. The cryogenic liquid pumps are fixedly secured to an interior surface of the cryogenic liquid storage tanks in a horizontal orientation, which can be at the bottom of the tank. Alternatively, conventional cryogenic liquid pumps may be external to the storage tank.

### SUMMARY

The subject matter of the present application has been developed in response to the present state of the art, and in particular, in response to the problems and needs of cryogenic liquid storage tanks that have not yet been fully solved by currently available storage tanks. One problem of conventional cryogenic liquid storage tanks is the need for a service person to enter the storage tank in order to service the pump, which increases the time and effort necessary to service the pump. Because the pump is fixedly secured to the inner surface of the tank, the pump cannot be installed, removed, or serviced without the service person entering the storage tank. Further, the storage tank must be entirely vacated (e.g., purged) of cryogenic liquid and warmed before the service person can enter the storage tank.

Another problem with traditional cryogenic liquid storage tanks is that the liquid pumps are fixedly secured to the inner surface of the tanks in a horizontal configuration (e.g., on a side or bottom of the pumps). Due to the size and configuration of such pumps, and the need for the pumps to be submerged in liquid for proper operation, a significant amount (e.g., 1 foot or more) of cryogenic liquid must be left in the storage tank at all times, which limits how low the liquid level can be pumped before the pump must stop or lose suction. For this reason, the refill frequency for conventional storage tanks is unnecessarily high, and often an external sump or mini cryogenic vessel is required in concert with the bulk cryogenic liquid storage tank to address this problem. Additionally, due to the dimensional aspect ratio of conventional submerged pumps (i.e., the length of the pump exceeds the diameter, which makes the pump elongate in the lengthwise direction), even more product would have to be left in the tank at all times if the pump were mounted vertically within the cryogenic tank.

Regarding pumps/sumps that are external to the storage tanks, such external sumps are not as thermally efficient as pumps that are positioned within the storage tank and thus more heat ‘leaks’ into the external sump. While external sumps can be configured with insulation or with a vacuum-jacket, vacuum-jacketed, the cost of vacuum jacketed sumps is generally excessive.

Additionally, a problem with conventional storage tanks is the necessity for and complexity associated with the high number of external piping and valves required to operate an external sump or mini cryogenic vessel.

In view of the foregoing, the subject matter of the present application has been developed to provide a cryogenic liquid storage tank and associated pump assembly that overcome many of the shortcomings of the prior art.

Disclosed herein is one embodiment of a liquid storage tank system that includes a liquid storage tank, a receiver, and a pump housing. The liquid storage tank includes an inner surface that defines an interior of the liquid storage tank, the receiver is secured to the inner surface and the receiver defines a receptacle, and the pump housing defines a chamber within which a liquid pump is retained, the receptacle being sized to removably receive and orientate the pump housing in a vertical orientation.

According to one implementation, the pump housing includes an inlet and the liquid storage tank system further includes a strainer that is coupled to the pump housing in fluid providing communication with the inlet. The system may further include an elongate pump support fixedly secured to the pump housing to suspend the pump housing from a top portion of the liquid storage tank.

In one implementation, the liquid storage tank has a manway opening and the liquid storage tank system further includes a lid that removably cover is the manway opening, with the elongate pump support being fixedly secured to the lid. The elongate pump support may define a fluid conduit having an end portion fluidly coupled to the chamber of the pump housing. In one implementation, the receiver prevents lateral movement of the pump housing when the pump housing is removably received by the receptacle of the receiver. In another implementation, the receiver is secured to the inner surface proximate a lowermost point on the inner surface of the liquid storage tank. The receiver may also include guides extending upwardly and radially outwardly from the receptacle, the guides defining a pump housing catch area that is larger than an area of the receptacle.

In one implementation, each guide comprises a contact surface that receives the pump housing and guides the pump housing into the receptacle, with the contact surface being angled with respect to a central axis of the receiver. In another implementation, the system may further include a manway assembly coupled to the liquid storage tank and the manway assembly may include a pressure regulation system. In such an implementation, the manway assembly may include a riser, a lip coupled to the riser, and an outer lid movably supported on the lip. Accordingly, the pressure regulation system may have fastener assemblies that each include a fastener extending through the lip and the inner lid and a biasing member engaged with the lip and the fastener to bias the inner lid against the lip. In one implementation, each of the fastener assemblies further includes a stop fixed to the fastener, the stop interposed between the lip and engageable with the lip to prevent movement of the fastener away from the lip.

Also disclosed herein is one embodiment of a liquid pump assembly for a liquid storage tank. The liquid pump assembly includes fluid discharge piping through which a liquid stored in the liquid storage tank is flowable and a pump housing secured to and suspended from the fluid discharge piping, the pump housing defining a chamber. The liquid pump assembly also includes a liquid pump that is retained within the chamber, the liquid pump being operable to pump liquid in the chamber through the fluid discharge piping.

In one implementation, the liquid pump assembly further includes an inner manway lid. In such an implementation, the fluid discharge piping has a first end portion fixed to the inner manway lid and a second end portion fixed to the pump housing. The fluid discharge piping, pump housing, liquid pump, and inner manway lid, according to one implementation, are non-movably fixed relative to each other.

In one implementation, the fluid discharge piping is elongate in a first elongate direction and the pump housing is elongate in a second elongate direction, with the first elongate direction being parallel to the second elongate direction. The liquid pump assembly may further include an inner manway lid co-planar with a first plane. In such an implementation, the fluid discharge piping has a first end portion fixed to the inner manway lid and a second end portion fixed to the pump housing, the first and second elongate directions being transverse to the first plane. In one implementation, the liquid pump assembly further includes a receiver fixedly securable to an inner surface of the liquid storage tank. The pump housing may be removably received by the receiver to orientate the pump housing and liquid pump in a vertical orientation within the liquid storage tank.

Also disclosed herein is one embodiment of a method of assembling a liquid storage tank system having a liquid storage tank that defines an interior and that has a manway opening providing access to the interior. The method includes lowering a liquid pump assembly through the manway opening of the liquid storage tank into the interior of the liquid storage tank. The liquid pump assembly has a manway lid and a fluid discharge piping that includes a first end portion and a second end portion opposing the first end portion, the first end portion being fixedly secured to the manway lid. The liquid pump assembly further includes a pump housing fixedly secured to the second end portion of the fluid discharge piping, the pump housing being suspended from the manway lid via the fluid discharge piping as the liquid pump assembly is lowered, with the pump housing defining a chamber. The liquid pump assembly also includes a liquid pump retained within the chamber of the pump housing, the liquid pump being operable to pump liquid in the chamber through the fluid discharge piping. The method further includes covering the manway opening with the manway lid of the liquid pump assembly, and suspending suspending the pump housing within the interior of the liquid storage tank once the manway lid is the manway opening.

In one implementation, lowering the liquid pump assembly includes lowering the pump housing into a pump receiver fixed to an interior surface of the liquid storage tank to retain the pump housing in a vertical orientation within the interior of the liquid storage tank.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings.

FIG. 1 is a perspective view of a cryogenic liquid storage tank according to one embodiment;

FIG. 2 is a top view of the cryogenic liquid storage tank of FIG. 1, which shows two manways each associated with one of two submerged pump assemblies;

FIG. 3 is a detailed top view of manway assemblies of the cryogenic liquid storage tank of FIG. 1;

FIG. 4A is a perspective view of a pump assembly for a cryogenic liquid storage tank according to one embodiment;

FIG. 4B is a cross-sectional end view of a cryogenic liquid storage tank with a pump assembly according to one embodiment;

FIG. 5 is a top view of an open manway assembly (with an outer manway lid removed) of a cryogenic liquid storage tank showing an inner manway lid assembly from which a pump assembly positioned internally within the storage tank is suspended according to one embodiment;

FIG. 6 is a partially transparent side view of a pump assembly within a storage tank according to one embodiment;

FIG. 7 is a partially transparent perspective view of a receiver of a pump assembly according to one embodiment;

FIG. 8 is a perspective interior view of a manway assembly of a cryogenic liquid storage tank according to one embodiment;

FIG. 9 is a perspective exterior view of a manway assembly of a cryogenic liquid storage tank according to one embodiment; and

FIG. 10 is a detailed perspective view of fastener assemblies of a manway assembly according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

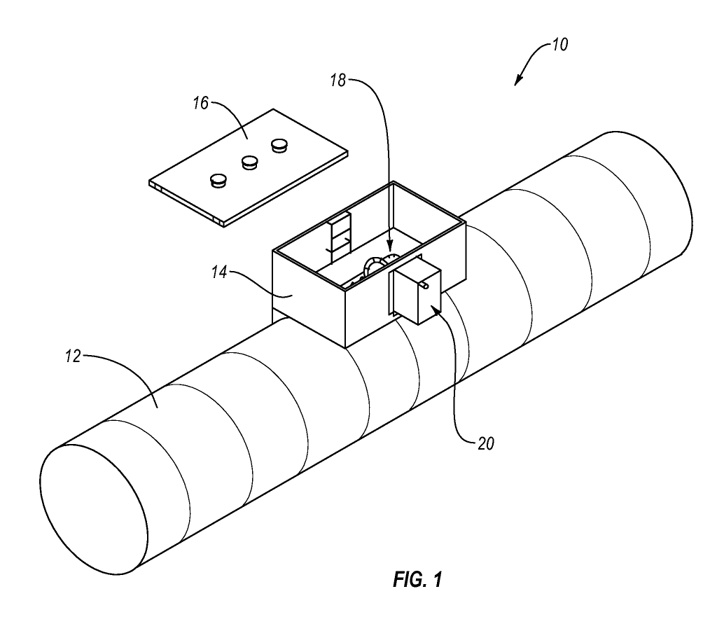

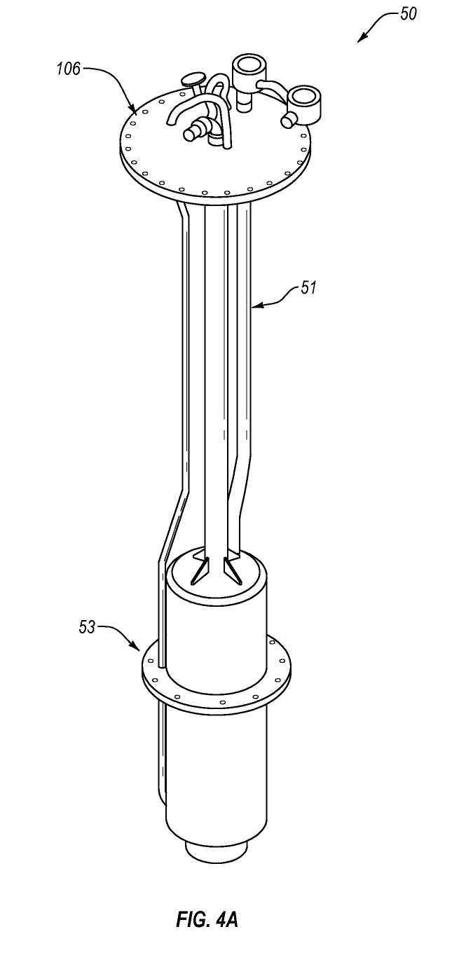

As shown in FIG. 1, according to one embodiment, a storage tank system 10 includes a storage tank 12 for storing a cryogenic liquid, such as liquid natural gas (LNG). The storage tank 12 can be a dual-walled tank that includes an inner tank or storage vessel 38 surrounded by an outer tank or shell 36 (see, e.g., FIG. 4B). Although not shown, an insulating material can be positioned between the inner tank 38 and outer tank 36. Alternatively, the storage tank 12 can be vacuum insulated. The cryogenic liquid is retained within an interior 40 of the inner tank 38 (see, e.g., FIG. 4B). The storage tank system 10 can be configured for aboveground or belowground use. Additionally, the storage tank system 10 can be used in mobile or non-mobile applications.

In the depicted embodiment, the storage tank system 10 is configured for belowground use. Accordingly, the system 10 includes a tank riser 14 and cover 16 to facilitate access to the storage tank 12 when the tank is buried underground. The cover 16 can be positioned aboveground and be removable, or movable (e.g., pivotable), to allow access to the tank 12, and more specifically, the manway assemblies 18 of the tank. All or a portion of the riser 14 may be positioned underground. The storage tank system 10 can also include a trench adapter 20, or conduit and piping interface, coupled to the riser 14. The trench adapter 20 contains fluid piping and communication conduits that extend between a surface-mounted fluid dispensing system (not shown) and the storage tank 12.

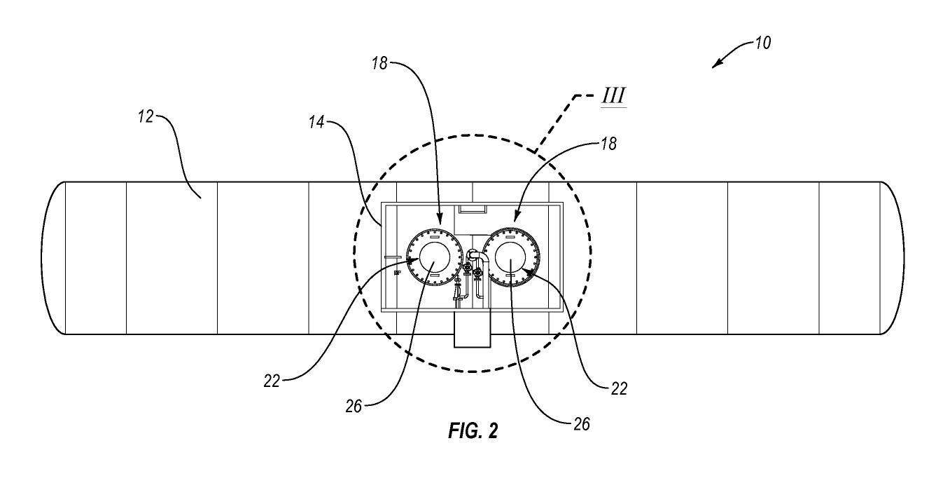

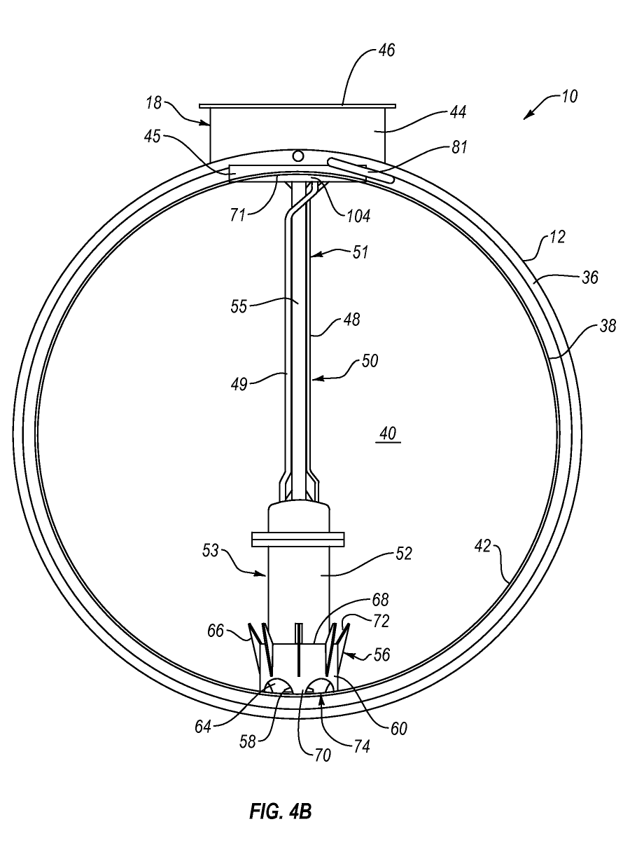

Referring to FIG. 2, the storage tank system 10 includes two manway assemblies 18 coupled to a top portion of the storage tank 12. Although the storage tank system 10 in the embodiment depicted in FIG. 2 includes two manway assemblies 18, each associated with a respective pump assembly, in other embodiments, the storage tank system can include only one manway assembly (see, e.g., FIG. 5) associated with one pump assembly or more than two manway assemblies associated with more than two pump assemblies. In another embodiment, multiple pump assemblies may be associated with a single manway assembly. For example, three pump assemblies in a triangular configuration may be suspended from a single manway assembly.

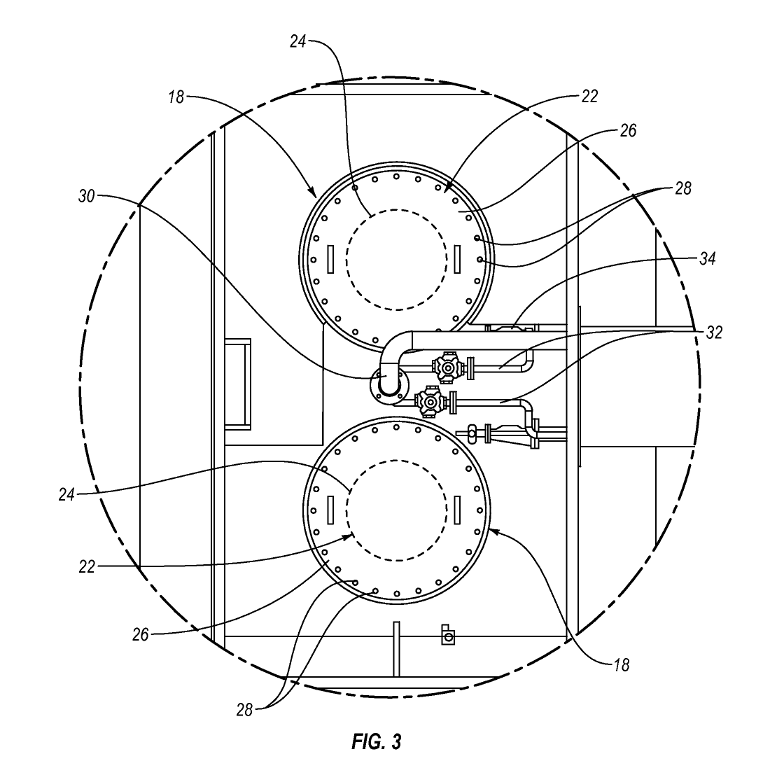

As shown in FIGS. 2 and 3, each manway assembly 18 includes a manway cover assembly 22 and a manway opening 24. The manway opening 24 is an opening in the storage tank 12 through which the interior 40 of the storage tank is accessible. As will be described in more detail below, the manway opening 24 is sized to allow passage of a pump assembly 50 into and out of the storage tank 12. Additionally, if necessary, a person may enter and exit the storage tank 12 through the manway opening 24 for cleaning and maintenance of the storage tank. In one embodiment, the storage tank 12 includes an inner tank 38 and an outer tank 36 (see, e.g., FIG. 4B). Accordingly, the manway 18 may include an inner opening in the inner tank 38 and an outer opening in the outer tank 36. The manway opening 24 may be at least partially defined by a bellows 45 welded to the outside of the inner tank 38 (see, e.g., FIG. 4B). Each manway opening 24 is covered by a respective manway cover assembly 22, which may include an outer lid 26 covering the outer opening in the outer tank 36 and an inner manway lid or cap 106 covering the inner opening in the inner tank 38. The manway cover assembly 22 may also include a plurality of fastener assemblies 28. Referring to FIG. 4A, the inner manway lid or cap 106 may be a component of the pump assembly 50 as will be explained in more detail below.

The storage tank system 10 also includes a plurality of conduits and piping extending into and out of the storage tank 12. In the illustrated embodiment of FIG. 3, the piping includes a vent 30, pump discharge piping 32, and a liquid supply piping 34. The vent 30 facilitates the venting of gas from the storage tank 12. The pump discharge piping 32 is fluidly coupled to respective liquid pumps of the pump assemblies 50 and receives liquid pumped from the storage tank via respective fluid discharge piping (e.g., fluid discharge piping 55 as shown in FIG. 4B) within the tank. Additionally, the pump discharge piping 32 is coupled to cryogenic liquid receivers (not shown) that receive and store cryogenic liquid pumped from the storage tank. The liquid supply piping 34 is fluidly coupled to a cryogenic liquid source to receive fluid from the source. Further, the liquid supply piping 34 is in fluid providing communication with the storage tank 12 to supply the storage tank with cryogenic liquid from the source.

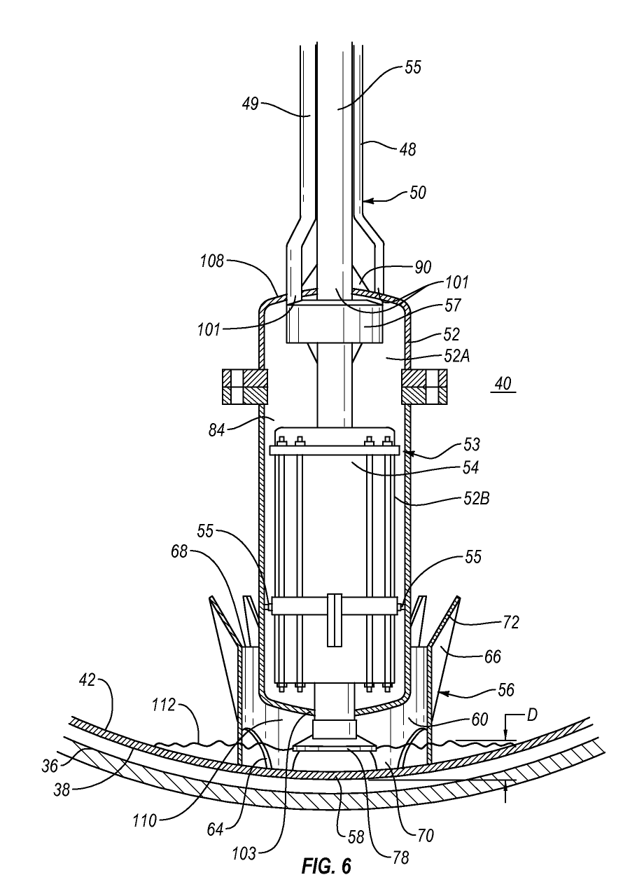

Referring to FIGS. 4A-8, according to one embodiment, the storage tank system 10 includes a pump assembly 50 positioned within the interior 40 of the storage tank 12. The pump assembly 50 extends from proximate a lowermost point 58 of the inner tank 38 to a top portion 71 of the inner tank. As defined herein, the lowermost point 58 of the inner tank 38 is dependent on the position of the inner tank. Accordingly, the lowermost point 58 can be defined as the lowermost point of the inner tank when the inner tank is in a final resting position, which can be a horizontal orientation in some implementations. The final resting position can be on the ground or on a mobile platform, such as a trailer. Generally, as shown in FIGS. 4A and 4B, the pump assembly 50 includes a suspension portion 51, a pump portion 53, and the inner manway lid 106. The pump portion 53 is positioned proximate the lowermost point 58 of the tank 38, the suspension portion 51 extends between the pump portion and the manway assembly 18, and the inner manway lid 106 is secured to a lower portion of the manway assembly and covers (e.g., seals) the inner opening of the inner tank 38. The suspension portion 51, pump portion 53, and inner manway lid 106 are non-movably fixed relative to each other such that the entire pump assembly 50 can be moved together as a single unit. The suspension portion 51 may be non-flexible in some embodiments, but in other embodiments, the suspension portion can be flexible. The suspension portion 51 extends substantially transversely away from the inner manway lid 106 (e.g., transversely away from a plane that is co-planar with the inner manway lid) in some implementations.

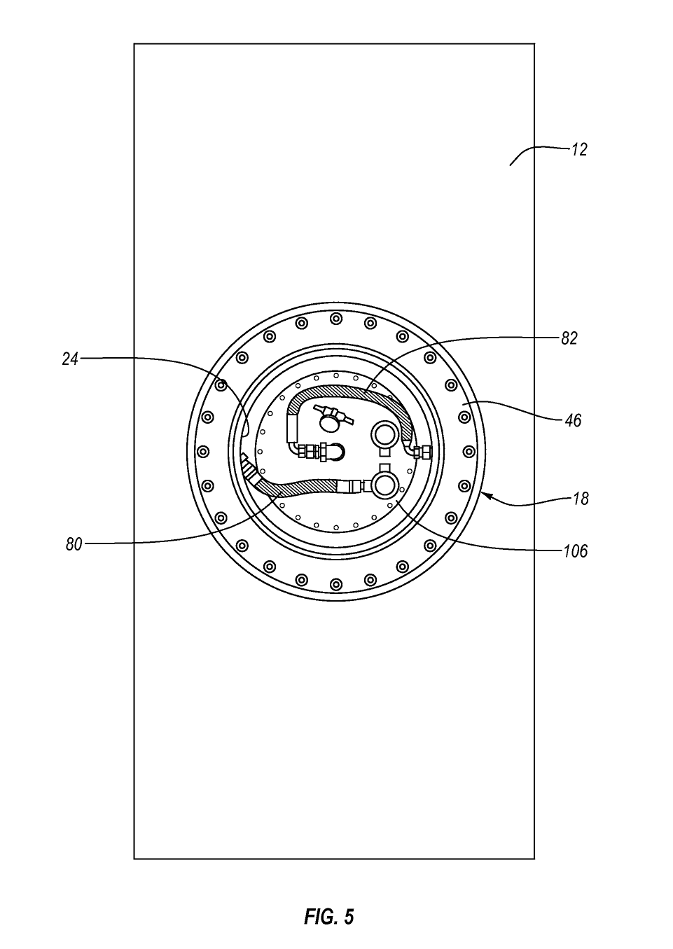

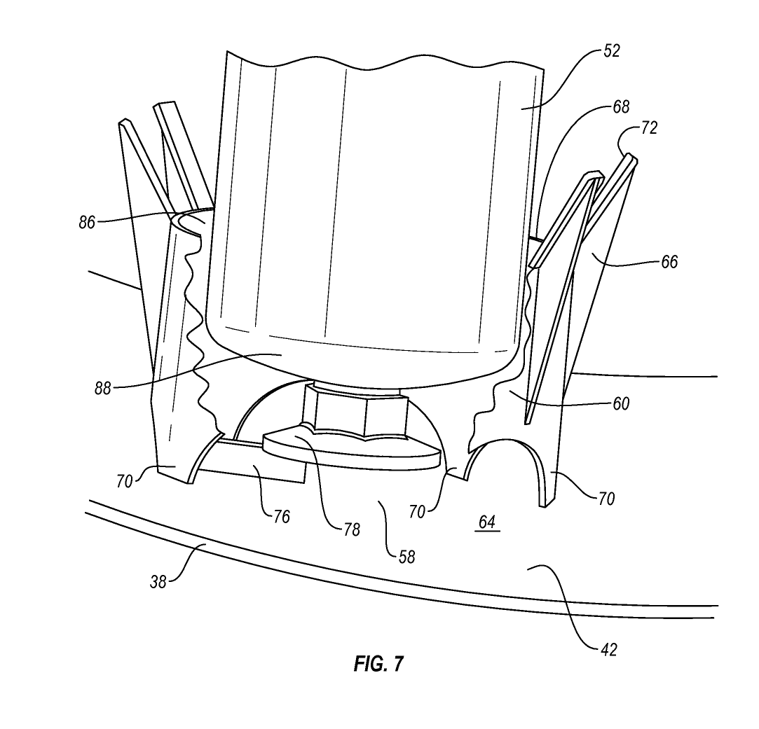

The suspension portion 51 includes piping and structures. For example, the suspension portion 51 includes a purge line or piping 48 and an electrical conduit 49. Additionally, the suspension portion 51 includes the fluid discharge piping 55, which, when the pump assembly 50 is in place within the tank 38, suspends or positions a pump housing 52 of the pump portion 53 just above the lowermost point 58 of the tank 38. In one embodiment, the pump discharge piping 55 can be an elongate length of material, such as a tube, made from a rigid material, such as metal. A top end of the pump discharge piping 55 is fixedly secured (e.g., via welding) to the cap or inner manway lid 106 covering the lower portion of the manway assembly 18 (see, e.g., FIG. 8). The manway assembly 18 is secured to the inner tank 38. The bottom end of the pump discharge piping 55 is fixedly secured (e.g., via welding) to a top end of the pump housing 52. To reinforce the strength of the coupling between the ends of the pump discharge piping 55 and the inner manway lid 106 and pump housing 52, respectively, as well as to reduce lateral movement of the pump discharge piping relative to the tank, a plurality of gussets 90 can be secured to and extend between the pump discharge piping and inner lid (see, e.g., FIG. 8), and between the pump discharge piping and the top of the pump housing (see, e.g., FIG. 6). The pump discharge piping 55 can be fluidly coupled to liquid discharge piping 82 that is removably or fixedly secured to an outer surface of the inner manway lid 106 (see, e.g., FIG. 5). The liquid discharge piping 82 may be stainless steel tubing, cryogenic stainless steel flex-hoses, or the like. The suspension portion is significantly longer than a length of the pump housing 52 in some embodiments.

Similarly, as shown in FIG. 5, the electrical conduit 49 can be electrically coupled to an electrical conduit 80 that is removably secured to an outer surface of the inner manway lid 106. The electrical conduit 80 and liquid discharge piping 82 can be coupled to a respective electrical conduit and liquid discharge piping that pass through the interstitial space between the outer and inner tanks 36, 38 before exiting the outer tank. For example, as shown in FIG. 4B, an electrical conduit 81 receives an electrical wire from the electrical conduit 80. The electrical conduit 81 passes through the interstitial space between the outer and inner tanks 36, 38 before exiting through the outer tank.

According to some embodiments, the electrical conduit 49 on the inner surface of the inner manway lid 106 is coupled to the electrical conduit 80 on the outer surface of the inner manway lid via a pass-through electrical fitting fixed to the outer surface of the inner manway lid. A secondary in-line, or in-series, backup pass-through electrical fitting may also be fixed to the outer surface of the inner manway lid 106 to provide a redundant electrical line. Similarly, a pass-through fluid fitting fixed to the outer surface of the inner manway lid 106 may be used to fluidly couple together the pump discharge piping 55 on the inner surface of the inner manway lid and the liquid discharge piping 82 on the outer surface of the inner manway lid. As defined herein, in some embodiments, an “inner” feature is defined to mean a feature facing the interior 40 or positioned inwardly or closer to an interior (e.g., the interior 40) of the storage tank 10 than an “outer” feature, which can be defined to mean a feature facing an exterior of the storage tank or positioned outwardly or further away from the interior of the storage tank than the “inner” feature.

The pump portion 53 of the pump assembly 50 includes the pump housing 52, which houses a liquid pump 54. The liquid pump 54 can be a submerged cryogenic liquid pump in some embodiments. Additionally, the pump assembly 50 includes a pump receiver 56, which receives at least a portion of the pump housing and keeps the pump housing and assembly in place (e.g., limits movement) during use and transport. The pump housing 52 includes a generally hollow elongate structure that defines a pump chamber 84 therein (see, e.g., FIG. 6). In certain implementations, the pump housing 52 is a generally cylindrically-shaped canister or capsule with a hollow interior that defines the pump chamber 84. The pump housing 52 is sized and shaped to receive and substantially enclose the pump 54 in the chamber 84. In some implementations, the pump housing 52 includes one or more brackets 55 or tabs positioned near a lower portion of the pump to fixedly secure the pump 54 in place within the chamber 84. Additionally, although not shown, a plurality of stabilization tabs may be secured between a discharge or upper end portion of the pump 54 and an interior wall of the pump housing 52 to stabilize the pump. Further stabilization of the pump 54 relative to the housing 52 can be provided by threadably engaging the lower portion of the pump, or fluid intake end of the pump, with a lower portion of the housing.

The pump housing 52 may include two sections 52A, 52B secured to each other according to any of various coupling methods. The top section 52A defines a top end 108 of the housing 52, and the bottom section 52B defines a bottom end 110 of the housing. In one embodiment, the top and bottom sections 52a, 52B are fluidly isolated from each other. The top section 52A defines openings 101 through which the pump discharge piping or discharge piping 55 and electrical conduit 49 extend into the chamber 84. The openings 101 in the top section 52A can be located at the top end 108 of the housing 52. The pump discharge piping 55 is fluidly coupled to the pump chamber 84, which receives fluid from an outlet of the pump 54, and the communication conduit 49 houses an electrical wire that is electrically coupled to the pump 54. The bottom section 52B includes an opening 103 formed in the bottom end 110. The opening 103 in the bottom end 110 receives a strainer 78 of the pump assembly 50. The purge line 48 may also extend through an opening 101 in the top section 52A, such as a top end 108 of the top section, as shown. Alternatively, the drain/purge line 48 may be routed externally about the housing 52 from the top end 108 to the bottom end 110, and extend through an opening in the bottom end. An interface between the top and bottom sections 52A, 52B, or other coupling, may be configured to receive and at least partially support in place an externally routed drain/purge line.

The strainer 78 includes filter media structured to filter out impurities and contaminants from the cryogenic liquid as the liquid passes from the interior 40 of the tank 12, through the strainer 78, and into the pump chamber 84 during pumping operations. In some embodiments, the strainer 78 has a substantially conical shape that diverges into a substantially cylindrical-shaped passage. An inlet of the strainer 78 is perpendicular to the vertical direction such that the inlet faces the lowermost point 58 of the inner tank 38. The strainer 78 may also be configured to prevent or at least mitigate the formation of a liquid vortex. For example, the strainer 78 may include vortex breaking formations or the strainer 78 may have a vortex inhibiting shape. In another embodiment, the shape and configuration of the pump receiver 56 may also contribute to the mitigation of vortexes.

The pump housing 52 is elongate in a top-to-bottom direction along a central axis that is parallel to a central axis of the pump 54. In the illustrated embodiment, the pump housing 52 is oriented in a vertical or upright orientation with the central axis of the housing being parallel with a vertical direction. In one embodiment, the pump 54 may be oriented horizontally while the pump housing 52 is oriented vertically. As defined herein, the vertical direction at a given location is parallel or aligned with the direction of the gravitational force at that location.

Referring to FIGS. 4 and 5, the pump assembly 50 includes the pump receiver 56, which in general terms, guides, receives, and retains at least the bottom end 110 of the pump housing 52 during installation and operation of the pump 54, as well as transportation of the tank 12. As mentioned above, the receiver 56 receives at least a portion of the pump housing and keeps the pump housing and assembly in place during use and/or transportation. The pump receiver 56 includes a base 60, feet 70, passages 64, and guides 72.

The base 60 is a substantially tubular member that defines a receptacle or passage 86 through which the pump housing 52 can extend. The receptacle 86 is sized to define a periphery that is at least slightly larger than an outer periphery of the pump housing 52. In some implementations, the receptacle 86 is sized to be complementary and form a slight interference fit with the pump housing 52. In other implementations, the receptacle 86 is sized to allow for some nominal or minimal lateral movement of the pump housing 52 when received within the receptacle 86. The receptacle 86 defines a vertical central axis that extends through the receptacle 86.

The feet 70 are coupled to or formed in a lower portion of the base 60. The pump receiver 56 includes a plurality of feet 70 spaced-apart about a periphery of the base 60. The feet 70 support the base 60 on the inner surface 42 of the inner tank 38 at the lowermost point 58 of the tank. In certain implementations, the feet 70 support the base 60 on the inner surface 42 at the bottommost location of the inner tank 38. The feet 70 can be fixedly secured (e.g., by welding or other coupling techniques) to the inner surface 42 of the inner tank 38 such that the pump receiver 56 is fixed relative to the inner tank.

The passages 64 of the pump receiver 56 facilitate the flow of cryogenic liquid 112 from a location proximate the lowermost point 58 of the inner tank 38 into the receptacle 86 defined by the base 60. In the illustrated embodiment, each passage 64 is defined between two adjacent feet 70. Although the passages 64 can have any of various shapes, the passages 64 of the illustrated embodiment each has a semi-circular shape. The shape of the passage 64 can assist in reducing the effect of liquid vortices on the ability of the pump 54 to efficiently draw in cryogenic liquid from the tank. Additionally, the use of a receiver 56 in general can aid in reducing liquid vortices in the cryogenic liquid 112 before being drawn (e.g., sucked) into the pump chamber 84. Although the passages 64 are defined by the feet 70 and the inner surface 42 of the inner tank 38, in some embodiments, passages can formed into the base 60 independently of the feet 70 and not be defined by the inner surface 42.

The guides 66 are spaced apart about the periphery of the base 60 proximate a top 68 of the base. As shown, the guides 66 are coupled to (e.g., welded to or formed integrally with) an outer side of the base 60, but extend vertically above upwardly higher than the top 68 of the base. In the illustrated embodiment, the guides 66 are generally triangular-shaped, but in other embodiments, the guides can have other shapes. Each guide 66 defines an angled guide surface 72 extending radially outwardly away from the base 60. Accordingly, the outer peripheries of the guides 66 define a pump housing catch area that is larger than an area (e.g., cross-sectional area) of the receptacle of the receiver 56. The angled guide surfaces 72 each defines an angle between 0-degrees and 90-degrees relative to the central axis of the base 60, which is parallel to the vertical direction when fixed to the inner surface 42 of the tank 38 in some embodiments. Although the illustrated embodiment includes a plurality of guides 66 each with an angled guide surface 72, in some embodiments, a conically-shaped receptacle nozzle with a single angled guide surface can be fixed to the top 68 of the base 60.

In alternative embodiments, the pump assembly 50 includes a differently configured pump receiver. For example, the pump receiver may include a plurality of alignment guides that are spaced about each other, and are secured to and vertically extend upwardly from a bottom of the inner tank 38. The alignment guides may include angled guide surfaces to guide the pump housing 52 as the housing is lowered into place. The alignment guides can be welded into place.

The configuration of the pump assembly 50 (e.g., the length of the discharge piping 55) positions an inlet of the strainer 78 a desired distance D away from the lowermost point 58 of the inner tank 38 (see, e.g., FIG. 6). The desired distance D is also equal to the minimum depth of cryogenic liquid allowed before the pump will lose prime (e.g., the minimum distance from the bottom of the tank which does not result in a restriction of low into the pump) and thus is to remain in the inner tank 38 before the tank is refilled. According to one implementation, the desired distance D is less than about 1 foot, and in other implementations, the desired distance D is less than about 4 inches.

The pump assembly 50 of the present disclosure facilitates a reduction in the complexity and time necessary for assembling and maintaining the storage tank system 10, and more specifically, installing and servicing a pump within the storage tank 12. Generally, for the installation of a new pump, or reinstallation of a serviced pump, the entire pump assembly 50, including the suspension portion 51 and pump portion 53, is unitarily lowered into the interior 40 of the inner tank 38 through the manway opening 24. In one embodiment, the pump assembly 50 is lowered by the cap 106 (e.g., inner manway lid). In other words, with the pump discharge piping 55 being fixedly secured to the cap 106 and the pump portion 53 being fixedly secured to the pump discharge piping, the cap can be secured and lowered to lower the entire pump assembly 50. As the pump assembly 50 is lowered, if the central axis of the pump housing 52 is not coaxially aligned with the central axis of the receiver 56, the bottom end 110 of the pump housing 52 should contact the guide surface 72 of one or more of the guides 66. Further lowering of the pump assembly 50 results in the bottom end 110 of the pump housing 52 sliding downwardly along the guide surface(s) until the bottom end of the pump housing engages and is received within the receptacle 86 defined by the receiver 56. Engagement with the receptacle 86 vertically aligns the pump housing 52 with the receptacle 86, which positions the pump housing 52 and associated pump 54 in a vertical orientation (e.g., transversely relative to the lowermost point 58). Accordingly, the guides 66 assist in capturing, guiding, and aligning the pump housing 52 such that the pump housing need not be perfectly aligned with the receiver 56 as the pump assembly 50 is lowered into the inner tank 38.

Additionally, lowering of the pump assembly 50 positions the strainer 78 at a desired distance D above the lowermost point 58, while the receiver 56 supports and retains the pump housing 52 in the vertical orientation. Moreover, the receiver 56 reduces, and in some instances substantially prevents, lateral movement of the pump housing 52 such that the pump housing is retained over the lowermost point 58.

Removing a pump from the storage tank system 10 includes disconnecting the electrical conduit 80 and liquid discharge piping 82, and securing and lifting the cap 106 vertically upward until the pump housing 52 passes through and clears the manway opening 24. In other words, because the pump housing 52 and associated pump 54 are not fastened to the inner surface 42 of the inner tank 28, but rather are secured to the inner manway lid 106, which is removably secured to the tank 12, removal of the pump 54 does not require physically entering the interior 40 of the inner tank and unfastening the pump from the inner surface of the inner tank.

As mentioned above, the pump assembly 50 is operable to pump cryogenic liquid from inside the inner tank 38 of the storage tank 12 to outside the storage tank 12. When the pump 54 is first initialized after the pump assembly 50 has been installed (e.g., when the pump is turned on), the pump draws liquid through the strainer 78 and into the pump via an inlet of the pump. The pump 54 then pumps the liquid out of the pump, through an outlet of the pump, and into the chamber 84. The liquid pumped out of the pump 54 fills the chamber 84 to submerge the pump. In one embodiment, the outlet of the pump 54 includes deflectors or other components that divert the liquid flow radially outward to facilitate filling up the pump chamber. Like many conventional pumps, the pump 54 may require submersion in the liquid to properly lubricate and cool the pump during operation. Positioning the pump 54 in the chamber 84 and filling the chamber with liquid allows the pump to be lubricated and cooled even when the level of liquid in the inner tank 38 drops below the height of the pump.

Once the chamber 84 is filled with cryogenic liquid, the liquid in the chamber 84 is forced through a chamber outlet 57 and into the pump discharge piping 55. The liquid flows upwards through the pump discharge piping 55 and into the liquid discharge piping 82 of the manway assembly 18. The outlet 57 may include apertures to direct initial flow from the pump into the pump chamber 84 to pressurize the chamber, and lubricate the pump, before the liquid is pumped into the pump discharge piping 55.

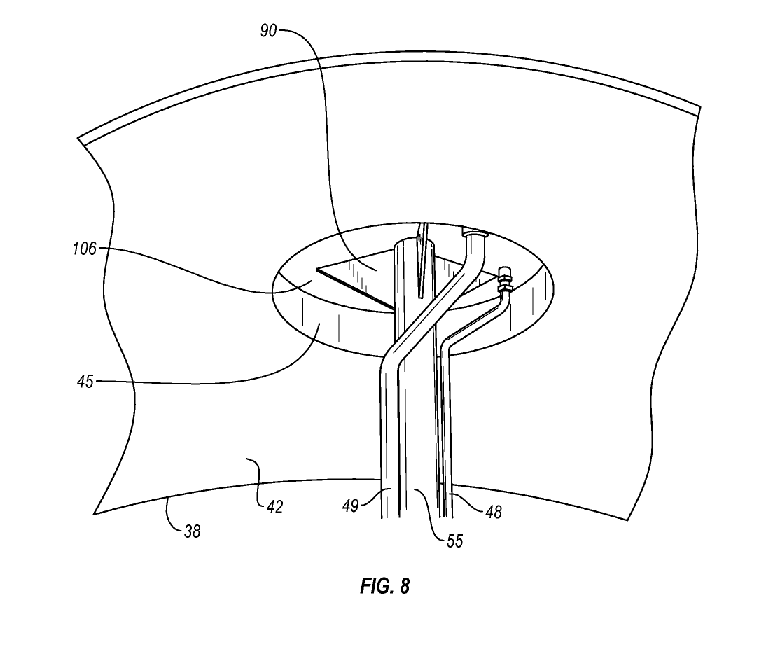

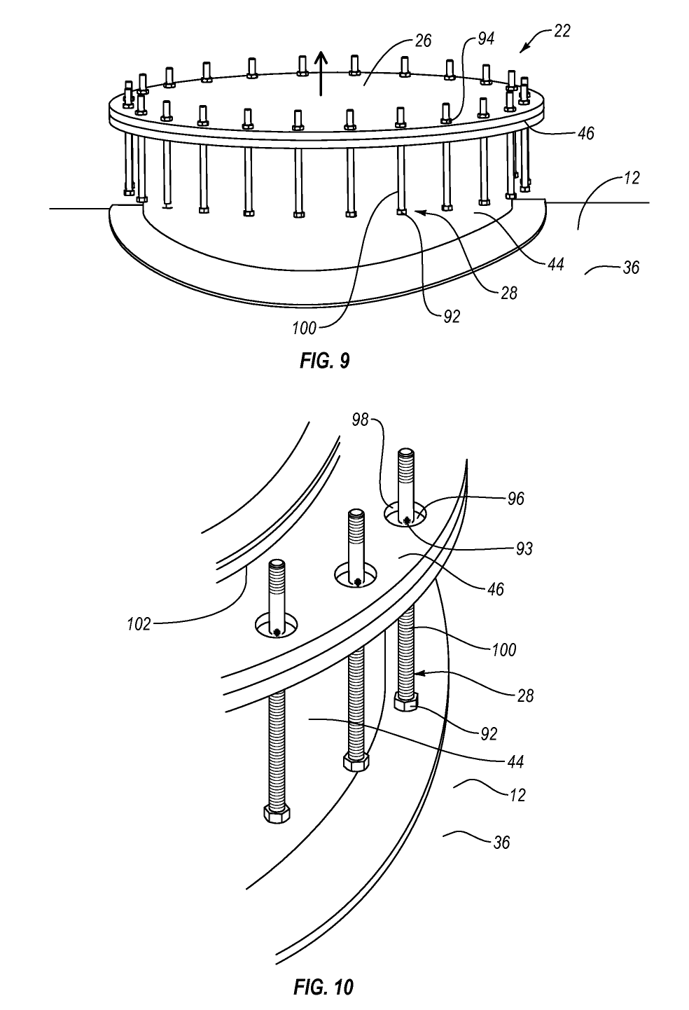

Referring to FIGS. 9 and 10, one embodiment of the manway assembly 18 includes the riser 44 and a pressure regulation system, which is secured to and extends vertically from an outer surface of the outer tank 36. Coupled to a top of the riser 44 is a lip 46 that extends circumferentially about the riser. The lip 46 can be separately formed from the riser 44 and attached to the riser, or integrally formed as a one-piece monolithic unit with the riser. The lip 46 includes an annular ring that extends radially outwardly away from the riser 44.

The lid 26 of the manway cover assembly 22 is secured onto the lip 46 via a plurality of fastener assemblies 28. Each fastener assembly 28 includes a bolt 92 that extends through respective aligned apertures in the lid 26 and lip 46. A nut 94 of each fastener assembly 28 is threadably engaged with an end portion of the bolt of the fastener assembly to retain the bolt. Additionally, each fastener assembly 28 includes a spring 100 (or other biasing member) through which the corresponding bolt 92 extends. The spring 100 is positioned between a head of the bolt 92 and the adjacent structure of the manway cover assembly 22. In the illustrated embodiment, the spring 100 is positioned between the head of the bolt 92 and the lip 46, with the nut 94 being directly adjacent the lid 26 such that the lid is between the nut and the lip. However, in other embodiments, the configuration can be reversed such that the spring 100 is positioned between the head of the bolt 92 and the lid 26, with the nut 94 being directly adjacent the lip 46 such that the lip is between the nut and the lid.

Further, the fastener assemblies 28 can each include a washer 96 or stop positioned within a recess 98 formed in a top surface of the lip 46 (or a bottom surface of the lid 26). Each washer 96 includes an aperture configured to receive a respective bolt 92. Furthermore, each washer 96 can be fixed to a respective bolt 92 (such as via a weld bead 93) to retain the bolt on the lip 46 when the nut 94 is removed, such as for servicing or during installation. To provide a fluid seal between the lid 26 and lip 46, a gasket 102 (e.g., o-ring) is positioned between the lid and lip as shown.

Generally, the fastener assemblies 28 secure the lid 26 on the lip 46, but allow the lid 26 to lift upward away from the lip 46 (as shown by direction arrow in FIG. 9) to vent pressure that may build up within the space defined within the riser 44 (e.g., between the outer manway lid 26 and inner manway lid 106). Preferably, the space within the riser 44 above the tank 12 is sealed from the contents of the tank. However, in some situations, pressurized gases may leak into the space within the riser 44, such as via the liquid discharge conduit 82 or inner manway lid 106. As the pressure within the space builds and overcomes a threshold pressure associated with the biasing force of the springs 100, the springs flex to allow the lid 26 to lift away from the lip 46 and allow the pressure within the space to be released to the atmosphere through the gap between the lid and lip. When the pressure within the space drops below the threshold pressure associated with the biasing force of the springs 100, the lid 26 lowers and the bias of the springs and weight of the lid 26 urges the lid 26 into secure engagement with the lip 46 and gasket 102.

Although not shown, in some embodiments, pressure regulation of the pressure regulation system may be provided via a pressure relief valve coupled to the outer lid 26. As the pressure within the space builds and overcomes a threshold pressure of the pressure relief valve, the valve opens to release pressure from within the bellows 45 between the outer lid 26 and inner lid 106. Also, a pressure gauge may be incorporated into the manway assembly 18. Additionally, a flammable gas detector may be positioned within the bellows 45 to detect the leakage of flammable gas within the bellows. In one embodiment, the bellows and the outer manway lid covering the outer opening of the outer tank 36 may be rated to withstand the same working pressure as the inner tank 38. Thus the outer manway portion may function as back-up containment vessel to contain, for example, fluid leaking from the inner tank 38.

Although not shown, insulation may be positioned within the bellows 45 of the manway assembly 18, between the outer lid 26 and inner lid 106, and about the electrical conduit 80 and the liquid discharge piping 82.

Although the illustrated embodiments have been described as being applicable to liquid storage tanks for storing a cryogenic liquid, in other embodiments, the principles and features of the present disclosure as described above are fully applicable to liquid storage tanks for storing liquids other than cryogenic liquids, such as diesel fuel and gasoline, among others.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, at least one of item A, item B, and item C″ may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A liquid storage tank system, comprising:
a liquid storage tank comprising an inner surface that defines an interior of the liquid storage tank;
a receiver secured to the inner surface, the receiver defining a receptacle; and
a pump housing defining a chamber within which a liquid pump is retained, the receptacle being sized to removably receive and orientate the pump housing in a vertical orientation.

2. The liquid storage tank system of claim 1, wherein the pump housing comprises an inlet, and the liquid storage tank system further comprises a strainer coupled to the pump housing in fluid providing communication with the inlet.

3. The liquid storage tank system of claim 1, further comprising an elongate pump support fixedly secured to the pump housing to suspend the pump housing from a top portion of the liquid storage tank.

4. The liquid storage tank system of claim 3, wherein the liquid storage tank comprises a manway opening and the liquid storage tank system further comprises a lid removably covering the manway opening, and wherein the elongate pump support is fixedly secured to the lid.

5. The liquid storage tank system of claim 3, wherein the elongate pump support defines a fluid conduit having an end portion fluidly coupled to the chamber of the pump housing.

6. The liquid storage tank system of claim 1, wherein the receiver prevents lateral movement of the pump housing when the pump housing is removably received by the receptacle of the receiver.

7. The liquid storage tank system of claim 1, wherein the receiver is secured to the inner surface proximate a lowermost point on the inner surface of the liquid storage tank.

8. The liquid storage tank system of claim 1, wherein the receiver comprises guides extending upwardly and radially outwardly from the receptacle, the guides defining a pump housing catch area that is larger than an area of the receptacle.

9. The liquid storage tank system of claim 8, wherein each guide comprises a contact surface that receives the pump housing and guides the pump housing into the receptacle, the contact surface being angled with respect to a central axis of the receiver.

10. The liquid storage tank system of claim 1, further comprising a manway assembly coupled to the liquid storage tank, wherein the manway assembly comprises a pressure regulation system.

11. The liquid storage tank system of claim 10, wherein:
the manway assembly further comprises:
a riser;
a lip coupled to the riser; and
an outer lid movably supported on the lip; and
the pressure regulation system comprises fastener assemblies each comprising:
a fastener extending through the lip and the inner lid; and
a biasing member engaged with the lip and the fastener to bias the inner lid against the lip.

12. The liquid storage tank system of claim 11, wherein each of the fastener assemblies further comprises a stop fixed to the fastener, the stop interposed between the lip and engageable with the lip to prevent movement of the fastener away from the lip.

13. A liquid pump assembly for a liquid storage tank, comprising:
fluid discharge piping through which a liquid stored in the liquid storage tank is flowable;
a pump housing secured to and suspended from the fluid discharge piping, the pump housing defining a chamber; and
a liquid pump retained within the chamber, the liquid pump being operable to pump liquid in the chamber through the fluid discharge piping.

14. The liquid pump assembly of claim 13, further comprising an inner manway lid, wherein the fluid discharge piping comprises a first end portion fixed to the inner manway lid and a second end portion fixed to the pump housing.

15. The liquid pump assembly of claim 14, wherein the fluid discharge piping, pump housing, liquid pump, and inner manway lid are non-movably fixed relative to each other.

16. The liquid pump assembly of claim 13, wherein:
the fluid discharge piping is elongate in a first elongate direction;
the pump housing is elongate in a second elongate direction; and
the first elongate direction is parallel to the second elongate direction.

17. The liquid pump assembly of claim 16, further comprising an inner manway lid co-planar with a first plane, wherein the fluid discharge piping comprises a first end portion fixed to the inner manway lid and a second end portion fixed to the pump housing, and wherein the first and second elongate directions are transverse to the first plane.

18. The liquid pump assembly of claim 13, further comprising a receiver fixedly securable to an inner surface of the liquid storage tank, wherein the pump housing is removably received by the receiver to orientate the pump housing and liquid pump in a vertical orientation within the liquid storage tank.

19. A method of assembling a liquid storage tank system having a liquid storage tank that defines an interior and comprises a manway opening providing access to the interior, the method comprising:
lowering a liquid pump assembly through the manway opening of the liquid storage tank into the interior of the liquid storage tank, the liquid pump assembly comprising:
a manway lid;
fluid discharge piping comprising a first end portion and a second end portion opposing the first end portion, the first end portion being fixedly secured to the manway lid;
a pump housing fixedly secured to the second end portion of the fluid discharge piping, the pump housing being suspended from the manway lid via the fluid discharge piping as the liquid pump assembly is lowered, wherein the pump housing defines a chamber; and
a liquid pump retained within the chamber of the pump housing,
the liquid pump being operable to pump liquid in the chamber through the fluid discharge piping;
covering the manway opening with the manway lid of the liquid pump assembly; and
with the manway lid covering the manway opening, suspending the pump housing within the interior of the liquid storage tank.

20. The method of claim 19, wherein lowering the liquid pump assembly comprises lowering the pump housing into a pump receiver fixed to an interior surface of the liquid storage tank to retain the pump housing in a vertical orientation within the interior of the liquid storage tank.
